(19) United States
(12) Patent Application Publication
(10) Pub. No.: US 2007/0188900 A1
(43) Pub. Date: Aug. 16, 2007

(54) Figuring of optical device for compensation of load-induced distortion

(75) Inventors: Lester David LaFleur, Bethel, CT (US); Brian James DeBoo, New Milford, CT (US); William Paul Zmek, Bethlehem, CT (US); Steven Sumner Prince, Danbury, CT (US)

Correspondence Address: EDWARDS ANGELL PALMER & DODGE LLP;(ALL COODRICH ENTITIES), P.O. BOXS 55874, BOSTON, MA, 02205, US

(73) Assignee: Goodrich Corporation, Charlotte, NC (US)

(21) Appl. No.: 11/699,108

(22) Filed: Jan. 29, 2007

Related U.S. Application Data
(60) Provisional application No. 60/763,222, filed on Jan. 30, 2006.

(51) Int. Cl. G02B 7/00

(52) U.S. Cl. 359/896

(57) ABSTRACT

A method of correction of load-induced optical distortion in an optical device includes subjecting an optical device having a first morphology to a predetermined loading condition, determining a deformation to a second morphology of the optical device under said predetermined loading condition, and removing material from at least one surface of said optical device to compensate for said deformation. In accordance with another aspect of the invention, the method can include the steps of subjecting the optical device to a predetermined loading condition, determining a deformation of the optical device under a predetermined loading condition, defining a surface contour across a surface of the optical device to substantially reduce wavefront error due to said deformation across a field of regard when the optical device is subject to said predetermined loading condition, and removing material from a surface of said optical device to create the defined surface contour.

### CROSS-REFERENCE TO RELATED APPLICATIONS

This application claims priority under 35 U.S.C. §119 to U.S. provisional patent application Ser. No. 60/763,222, filed Jan. 30, 2006, which is hereby incorporated by reference in its entirety.

### STATEMENT REGARDING FEDERALLY SPONSORED RESEARCH OR DEVELOPMENT

The United States Government has a paid-up license agreement in this invention and the right in limited circumstances to require the patent owner to license others on reasonable terms as provided for by the terms of contract 152102LE.

### FIELD OF THE INVENTION

The present invention relates to correction of load-induced distortion of optical devices, such as window panes, when exposed to certain loading conditions. Particularly, the present invention is directed to methods of determining and implementing corrective contours for one or more surfaces of such window panes and to window panes constructed in accordance with such methods.

### BACKGROUND

In extreme environments, optical devices, such as windows, are used to isolate an optical device, such as an imaging sensor, from the extreme environment. These optical devices would ideally perform as if they were infinitely strong, perfectly transparent, distortion-free barriers to the external environment. In practice, such ideal optical devices are not achievable. Accordingly, real optical devices are designed to be as neutral as practically possible with respect to their effect on the performance of the optical device that they shield. If an optical device in use is protecting a sensor having an intended high angular sensitivity (e.g., high resolution), such as an imaging sensor, then the “distortion-free” aspect of the optical device performance becomes particularly important. The term distortion-free, as used herein, means that the image collected by the sensor, looking through such an optical device, is not substantially degraded by the optical device.

One cause of a lack of optical neutrality, which results in distortion (bending of ray paths), is the potential for an optical device to be bent very slightly by the presence of environmental influences, such as gravity and/or differences in air pressure between the outside and inside environments that the optical device separates. FIG. 1 shows how an optical device, particularly an optical window 100, might bend in response to such loads. From the perspective of FIG. 1, the central region 110 is slightly distorted above the surrounding regions 120, gradually tapering to the original position around the rim 150 of the window 100.

FIG. 2 is provided to illustrate one way of understanding the cause of distortion through such optical devices. FIG. 2 illustrates two separate back-traced groups of rays originating at image points A1 and B1, respectively on an image plane 215 of an optical sensor 210. Each ray is equally spaced in angle with respect to adjacent rays of the same group. Tracing these paths back through the sensor to its collecting aperture 217, and beyond through the optical device 220, they would ideally converge again at respective distant points on the object being observed by the sensor—in this case, illustrated by object points A2 and B2 in the object plane 240. A large distance is indicated by arrows 230. If the optical device 220 is not optically neutral, it will bend the paths of the rays, relative to adjacent rays, such that the rays do not converge to a point, but rather, to a small scatter pattern, such as that of a shotgun pattern on a target, as illustrated by rays of group B, at point B2. This scatter pattern therefore sets a limit on how small a detail may be resolved of the object being observed. The wider the scatter pattern, the lower the resolution and contrast in an observed image.

Each group of rays A, B, passes through the optical device 220, and reacts to the window bending. The amount of relative ray bending depends on two factors. First, the deformation exhibited by, for example, a plano-parallel window under uniform environmental loads would not be deleterious if the shape of the bending were perfectly spherical, at least in the case of a small amount of bending typical of loads discussed herein. Unfortunately, although a spherical component of bending is present, the edges of a loaded plano-parallel plate, for example, resist assuming a spherical shape and tend to cause a slight flattening of an otherwise spherical shape. Even still, such behavior would not significantly impact performance without a second factor—specifically that a beam of light passing through the window does so at an angle relative to the normal to the surface to be problematic—as is the case with ray group B. Rays are not deflected relative to others if either of these conditions is not met. In other words, the wavefront would not be perturbed in shape under such conditions. Again, unfortunately, both frequently occur in practice.

FIG. 3 further illustrates two hypothetical angles for light incident on an optical device 320. In the left scenario 301, the light 310 encounters different surface shapes at the upper and lower surfaces of the optical device 320, respectively represented by incongruous lines 330a and 330b. The changes to the incident wavefront of light 310 introduced by the upper and lower surfaces of optical device 320 thus do not compensate for one another, leaving a net wavefront error in light 310 after transmission through optical device 320. On the other hand, in the scenario to the right 302, light 312 approaches the optical device 320 at an angle normal to the surface of the optical device 320. In this situation, light 312 encounters the same surface shape at the upper and lower surfaces of the optical device 320, illustrated by congruous lines 340a and 340b. Thus, the changes imparted to the wavefront of light 312 will be compensatory (equal and opposite) at the upper and lower surfaces of optical device 320, leaving light 312 free from wavefront errors after transmission through optical device 320. It should be noted that deformations in FIGS. 1-3 have been exaggerated for the purpose of clarity.

A flat plate of glass under a load, specifically, an optical window 100, is illustrated in FIG. 1. Such optical devices will always also exhibit some non-spherical deformation under the loads discussed herein. Moreover, sensors that look through such windows usually have the capability to scan their field of view, so that the sensors often look at transmitted beams of light that are not normal to the window, such as beam 310 in FIG. 3. In typical systems, therefore, both of the aforementioned conditions which together cause wavefront distortions will generally be present.

In accordance with typical methods of figuring a surface in order to cancel a system wavefront error, which may be called the “classical” approach, a transmitted wavefront that has passed through an optical system is measured, and then, based on this measurement, a compensating figure is polished into one of the optical surfaces in the system. This approach can compensate error quite well, but only for a single point in the field of regard. Systems that need to accommodate a wide field of regard, and which therefore experience large shifts of the beam footprint over its optical surfaces, cannot be treated successfully with such a simple approach. Accordingly, there remains a continued need in the art for an effective method for figuring an optical device, such as a window, intended for extreme environments, particularly in optical systems having a wide field of regard (“FOR”). The present invention provides a solution for the aforementioned problems.

### SUMMARY OF THE INVENTION

The purpose and advantages of the present invention will be set forth in and apparent from the description that follows. Additional advantages of the invention will be realized and attained by the methods and systems particularly pointed out in the written description and claims hereof, as well as from the appended drawings.

The present invention provides methods and optical devices made by such methods, involving correction of the effects of regular (lower-order) sources of wavefront error, such as external forces, which can include, but are not limited to, pressure differentials and/or gravitational forces. Such devices can include, but are not limited to plane-parallel plates and curved optical devices. Moreover, error sources such as index of refraction inhomogeneity of an optical material and/or nonuniformity of thickness of thin-film coatings applied to a surface of such optical devices can also be compensated.

In accordance with one aspect of the invention, a method of correction of load-induced optical distortion in an optical device is provided. The method includes subjecting an optical device having a first morphology to a predetermined loading condition, determining a deformation to a second morphology of the optical device under the predetermined loading condition, and removing material from at least one surface of the optical device to compensate for the deformation.

If desired, the second morphology can be determined using computerized modeling means or through physical inspection. As used herein, such subjection to a predetermined loading condition can be actual or virtual. For example, an optical device can be physically fabricated and placed in a test setup in which the optical device is subject to actual physical force. Such test setup can include a pressure chamber, for example. The behavior of the optical device can then be observed, and recorded, for use in determining from where material must be removed from the optical device. For this, a visible wavelength interferometer can be used, for example. Alternatively or additionally, such subjection to a predetermined loading condition can encompass computer-based simulations and the like, in which the characteristics of the optical device, such as shape and material properties, are input into a computer program, and the predetermined loading condition is similarly input into the computer program, which then calculates how the optical device will behave under such loading condition. The computed shape then can be used for determining how much as well as from where material must be removed from the optical device. Computer-based programs that can be used to perform such analysis include, but are not limited to Nastran® by MSC Software Corporation.

Embodiments of this aspect or other aspects of the invention can include one or more of the following features. Material can be removed from two surfaces to compensate for said mechanical deformation to yield an optical device having a substantially spherical morphology when subject to said loading condition. Alternatively, material can be removed from one surface of the optical device to optically compensate for said deformation by forming a surface adapted and configured to substantially reduce wavefront error due to said deformation across a field of regard. If so-embodied in the case of the foregoing embodiment, at least one surface of the optical device, when the optical device exhibits said first morphology, can have a radius of curvature of between about 1000 cm and infinity (a planar surface). Following the step of removing material from the optical device, the optical device can exhibit a third morphology when not subject to said predetermined loading condition, which third morphology is the inverse of said second morphology. The first morphology of said optical device can be substantially planar. The second morphology of said optical device can be substantially planar. The second morphology can be determined using computerized modeling means. The step of removing material can include polishing the surface of the optical device in selected areas or across the entire optical device. The step of polishing can be effectuated by a computer-controlled polishing device. If desired, both the first and second surfaces of the optical device can be polished to compensate for deformation. Moreover, between about 0.0005 inch and 0.005 inch (0.00127 cm to 0.0127 cm) of material can be removed by polishing, as required. Greater or lesser amounts of material can be removed, as required.

As used herein, the term “substantially” is used to describe aspects of the subject methods and/or optical devices made in accordance with such methods, with respect to optical behavior of light passing through such optical devices. That is, an objective of the subject invention is to minimize optical distortion of images obtained through an optical device. An ideal spherical or ideal planar optical device will exhibit minimal distortion of light passing therethrough. Accordingly, a “substantially” spherical device is used to describe a device that may not be precisely ideal in its sphericity, but which causes minimal distortion of light passing therethrough, which distortion must be minor and within any prescribed tolerances. Moreover, it should be understood that the term “spherical” is intended to encompass the term “planar.” Specifically, a plane can be defined as a sphere having an infinite radius of curvature.

In accordance with the invention, the step of removing material can include polishing the surface of the optical device in selected areas or across the entire surface of the optical device. Such polishing can be carried out manually or can be effectuated by a computer-controlled polishing device. In accordance with the invention, only one surface of the optical device can be polished to compensate for deformation, or first and second surfaces of the optical device can be polished to compensate for deformation, depending on the specific embodiment. In one embodiment, between about 0.0005 inch and 0.005 inch (0.00127 cm to 0.0127 cm) is removed by polishing the predetermined areas.

In accordance with another aspect of the invention, a method of optical correction of load-induced optical distortion in an optical device is provided. This method includes subjecting the optical device to a predetermined loading condition, determining a deformation of the optical device under a predetermined loading condition, defining a surface contour across a surface of the optical device to substantially reduce wavefront error due to said deformation across a field of regard when the optical device is subject to said predetermined loading condition, and removing material from a surface of said optical device to create the defined surface contour.

In accordance with this aspect of the invention or other aspects of the invention, wavefront correction may be achieved for any and all regions of the window defined by any and all possible footprints of transmitted light beams as they intersect the optical device. Contrary to the “classical method”, correction is not limited to certain regions, nor to discreet regions. Rather, the footprints of transmitted beams at various angles, all of which experience wavefront correction upon transmission through the optical device, may overlap and may likewise cover the entire optical device. In accordance with this aspect, a finite plurality of regions can be selected and used to define said surface contour using optimization techniques which minimize a wavefront error merit function. Further, material can be removed from only one surface of the optical device.

If desired, the steps of determining a deformation and/or defining a surface contour of the optical device can be carried out on a computer adapted and configured to determine the deformation and/or define such surface contour. In accordance with this aspect of the invention, the step of defining a surface contour can be carried out using optimization routines for a plurality of points in the field of regard (FOR). In accordance with this aspect, a computer-based program can be used, such as Zemax® by Zemax Development Corporation, CodeV® by Optical Research Associates or OSLO® by Lambda Research Corporation.

Further in accordance with the invention, an optical device is provided, which is made in accordance with any one of the methods set forth herein.

It is to be understood that both the foregoing general description and the following detailed description are exemplary and are intended to provide further explanation of the subject invention.

### BRIEF DESCRIPTION OF THE DRAWINGS

The accompanying drawings, which are incorporated in and constitute part of this specification, are included to illustrate and provide a further understanding of the methods and devices of the invention. Together with the description, the drawings serve to explain the principles of the invention, wherein:

FIG. 1 illustrates an exemplary optical device, and its bending response to an arbitrary loading condition;

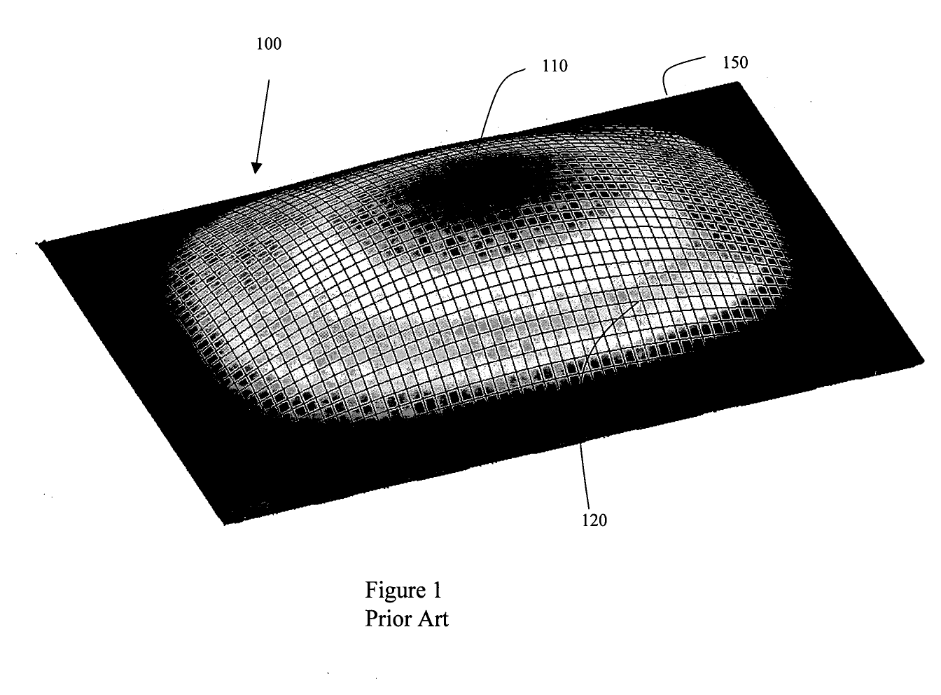

FIG. 2 illustrates two separate back-traced groups of rays spanning between respective object points and image points on an image plane of an optical sensor;

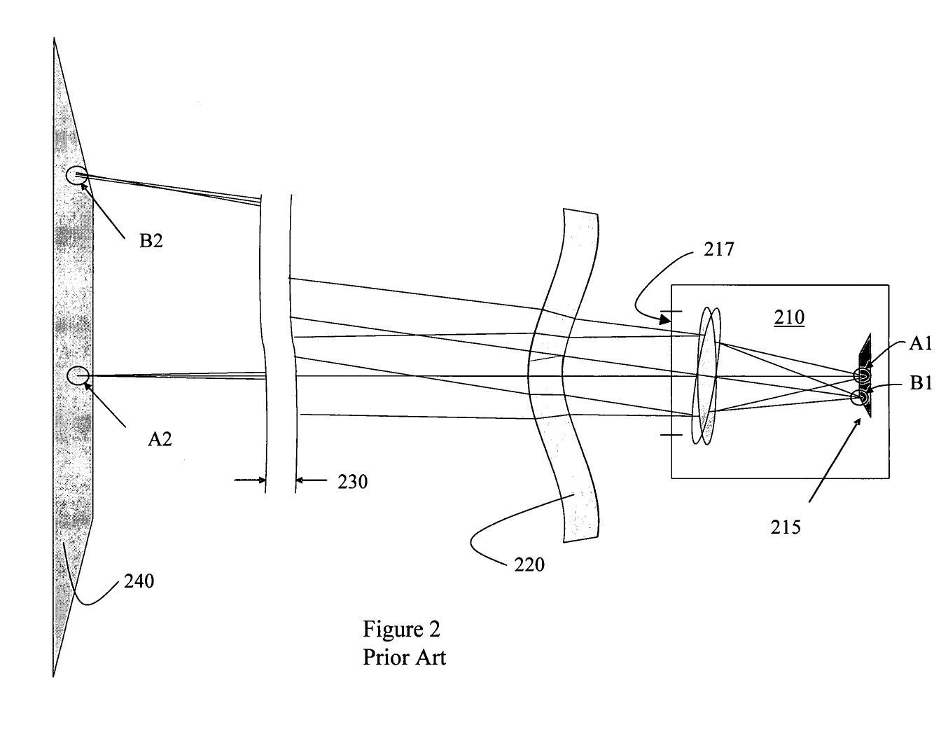

FIG. 3 illustrates light incident on an optical device at two different angles;

FIG. 4 illustrates a portion of an optical device at selected stages during performance of one method of the invention;

FIG. 5 is an illustration of beam footprints incident on an optical device 500 in accordance with the invention;

FIG. 6A is a ray diagram for light incident upon an optical device 600 in accordance with the invention, illustrating an angle of incidence, relative to a coordinate system;

FIG. 6B is a ray diagram for light incident upon an optical device 600 in accordance with the invention, component angles to the angle of incidence of FIG. 6A, relative to the coordinate system; and

FIG. 7 is a plot of RMS wavefront error with respect to angle of incidence α (alpha) and β (beta), as defined in FIG. 6B.

### DETAILED DESCRIPTION

Reference will now be made in detail to the present preferred embodiments of the invention. The methods presented herein may be used in fabricating optical devices for use under extreme loading conditions, where optical properties are of particular importance. Devices formed in accordance with methods set forth herein are particularly suited for use in vehicles requiring use of optical sensors, which are routinely exposed to environmental loads such as pressure differentials and gravitational effects. Such vehicles can include, for example, airplanes or submersibles. Pressure differentials can be experienced across optical devices operating underwater, or when operating in lower pressure atmospheric regions of the earth when contained in a pressurized chamber.

It is possible to counteract the effects of deformations described hereinabove by selective polishing, or “figuring,” of the optical device. Either one or two surfaces of an optical device can be treated by figuring, depending on the specific embodiment. In the case of treating both surfaces, in accordance with the invention, the inverse of the mechanical deformation under load that will occur in each side can be polished into each surface, to result in an optical device that has a planar, or more generally a spherical, shape under load.

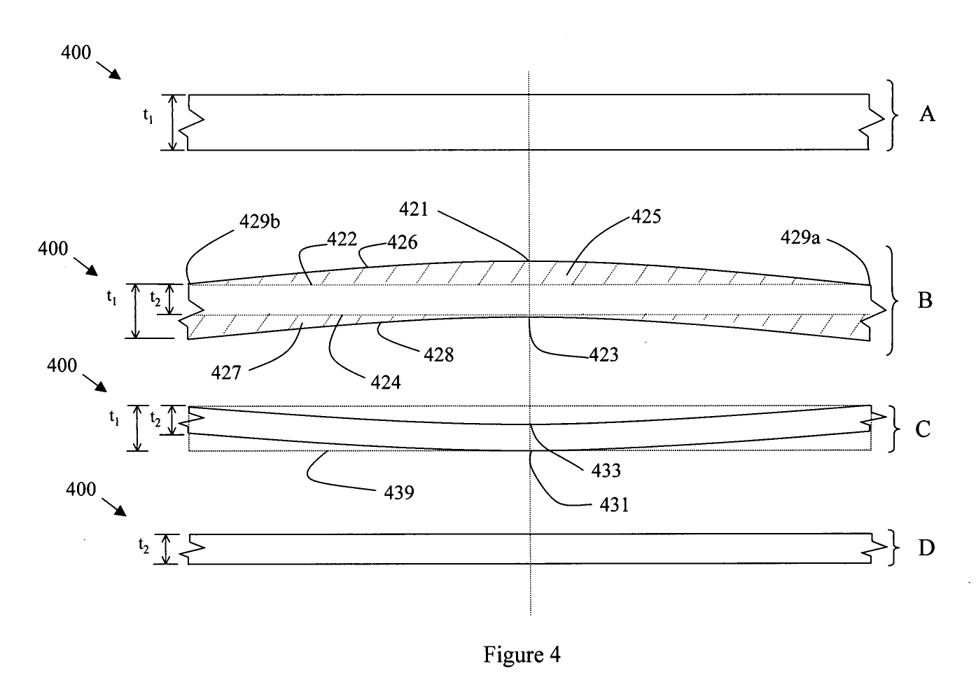

FIG. 4 illustrates various stages of a portion of an optical device 400 undergoing such treatment in accordance with this aspect of the present invention. In this embodiment, the optical device without load can be figured to have a generally opposite shape, or “morphology,” to the optical device with load. More particularly, the material removed to achieve such a shape need only be material that constitutes departure from a spherical shape, when the optical device is under load. That is, the morphology of the resulting optical device under load need not be precisely that of the original morphology (e.g., planar), provided that the shape of the device under load is at least spherical.

As an example of this aspect of the invention, FIG. 4 at stage A illustrates a portion of an optical device 400, having a plano-parallel morphology. The device is unloaded in this condition.

At stage B, the same optical device 400 is illustrated under a loading condition. The degree of deformation is exaggerated here for the purpose of providing a clear example. As set forth hereinabove, such a loading condition can be actual or virtual. That is, the optical device 400 can be physically deformed to determine the morphology it will exhibit, or alternatively, the deformation can be simulated by computer, with use of an appropriate program, such as Nastran® by MSC Software Corporation, for example. As illustrated, the material regions 425 and 427, delimited by dashed lines 422, 424 and the respective upper and lower surfaces 426, 428 of the optical device 400 are removed in accordance with the invention to create a widow under load that is piano-parallel. It is typically only necessary to remove material from an optical device to an extent that the optical device under load exhibits a spherical shape. However, for the purpose of illustration and not limitation, this example is provided and illustrated as stage B. As can be seen, the deformation of the optical device 400 results in a local maximum 421 and a local minimum 423 on the opposite surface. Additional local minima 429a, 429b exist on the upper surface 426 at respective ends of the illustrated portion of the optical device 400. Accordingly, in order to obtain a plano-parallel optical device under load, the most material must be removed in the region of local maxima, such as maximum 421, and no material need be removed from local minima, such as minima 423, 429a, and 429b.

The deformations under load of one surface (e.g. 421) of the optical device 420 are essentially equal but opposite the deformations of the other surface (e.g., 423) of the optical device 400, and therefore, the figure to introduce on one surface is the inverse of the figure to introduce on the other surface.

The result of the “figuring,” or material removal is set forth in stages C and D, which illustrate unstressed and stressed optical devices 400, respectively. As can be seen in stage C, following removal of material from the optical device 400, a local minimum 433 is formed when not under load, which correlates to the former local maximum 421 of the stressed optical device 400 while under load. Similarly, a local maximum 431 results where there had previously been a local maximum, because no material was removed from this area. Again, such maxima and minima exist only because the optical device 400 at stage C is shown without load. Accordingly, the morphology of the optical device 400 at stage C, is the inverse of the morphology of the optical device 400 at stage B. At stage D, the optical device 400 is once again loaded as in stage B, but has experienced material removal, and is therefore now plano-parallel under the same load as in stage B.

For the purpose of illustration, relative thicknesses of the optical device 400 at the various stages A, B, C and D are provided. The optical device, at least in the illustrated portion has a thickness t₁. In stage B, material is removed, resulting in a thickness of t₂, which carries through to stage D. In stage C, the former thickness t₁ is illustrated in phantom line for reference.

Once an optical device manufactured in accordance with the invention, e.g., optical device 420, is installed and the load is incurred, the deformation that the load imposes will be preferably precisely canceled by the optical device having the opposite deformation already formed into its surfaces. The result is ideally a plate having a spherical shape, and may be, for example plano-parallel in configuration. Even if the tolerances are such that the optical device is nearly ideally spherical, such shape will provide a good wavefront regardless of the angle of incidence of the transmitted beam collected by a sensor. As set forth hereinabove, it is typically only necessary to compensate that part of the deformation that constitutes a departure from a sphere. In other words, only the non-spherical component of the deformation may require treatment. Doing so will yield a spherically curved plate having a slightly circular cross section under load. A plano-parallel plate, as used herein, should be considered a subset of spherical plates. It should be understood that the deformations discussed herein are generally too small to see with the naked eye, but nevertheless can dramatically damage image quality.

It should also be understood that such treatment of an optical device—correcting the physical deformation of an optical device—is fundamentally different from the “classical” approach to figuring a surface in order to cancel a system wavefront error, as set forth above in the Background section. Compensating the mechanical deformation of the optical device by compensatory polishing, rather than simply compensating the wavefront error itself at a single point in the field of regard (“FOR”), is the key to this first method of full correction of the wavefront error over a wide FOR.

In accordance with a further aspect of the invention, a method for mitigating the effects of the distortion introduced by an optical device under load that compensates the wavefront error (WFE) collectively over the entire FOR is provided. The method includes determining a surface figure to form—by polishing or other means—into only one side of the optical device. This method has the advantage that the amount of material (e.g., glass) that needs to be removed to correct the WFE is much less than that for the foregoing 2-sided method. This approach is distinct from the classical method described above in the Background section. In order to avoid the fatal problem that the classical approach possesses in terms of applicability to optical devices (namely, having an extremely narrow FOR), a different, novel method of determining the figure to be achieved is necessary. In this new single-sided method, analysis is used to define the shape of one of the two surfaces of a load-deformed optical device that yields a minimum amount of wavefront error over the entire field of regard of a sensor, which senses light passing through the optical device. This is one substantial difference between the classical approach—which allows theoretically perfect correction but only at a single point in the FOR—and the present method. The present method allows substantial correction everywhere in the FOR. Naturally, an optical device can be treated in accordance with the invention to be corrected at every point of the optical device, or alternatively at certain locations thereon, as desired.

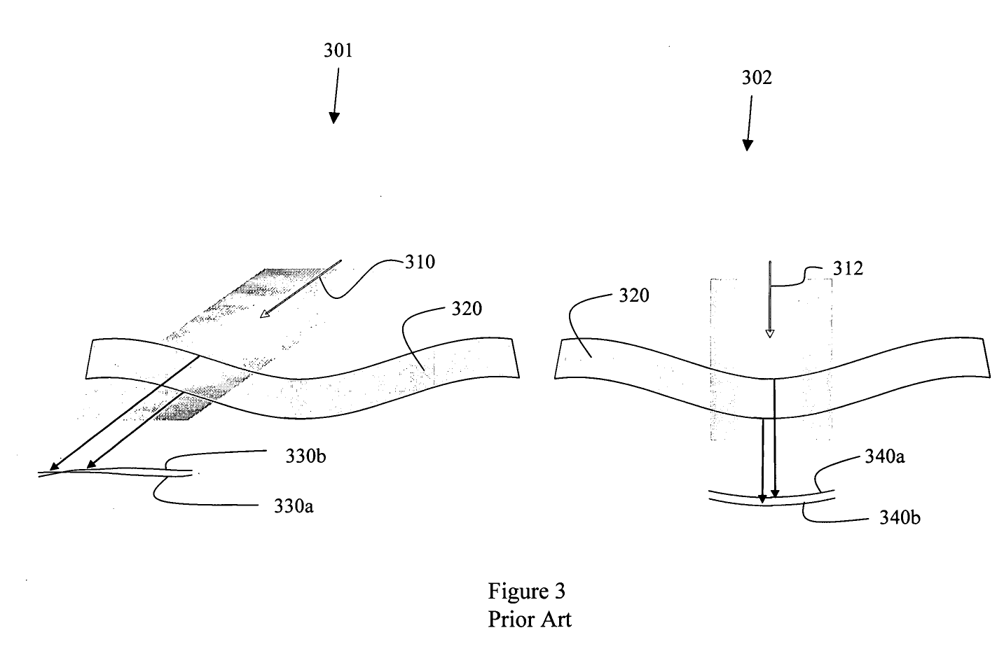

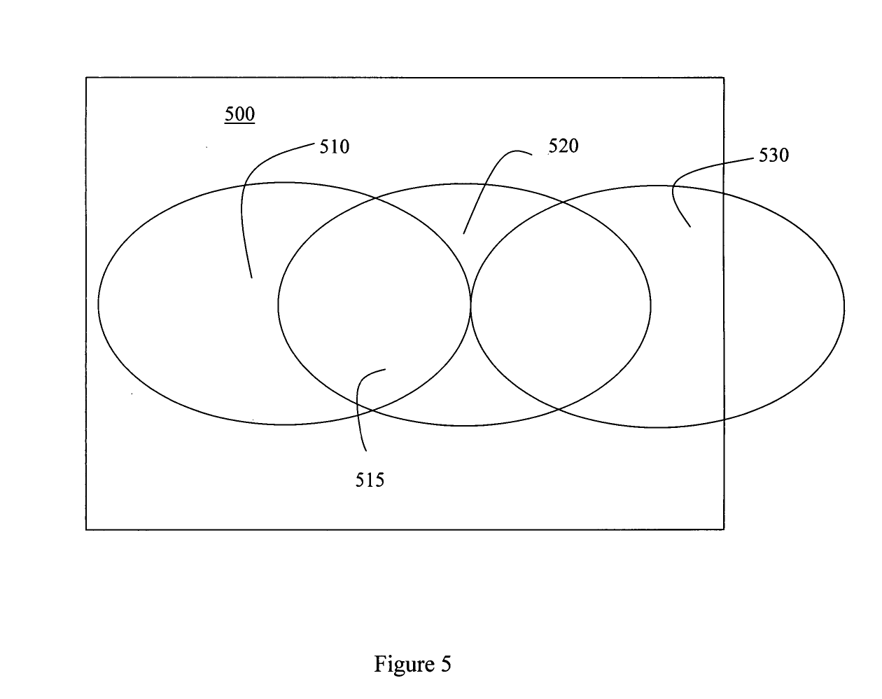

As illustrated in FIG. 5, the footprint (510, 520, 530) of each beam incident on the optical device 500, which will intersect a sensor only occupies a fraction of the area of the optical device 500, and because the location of that footprint 510, 520, 530 on the optical device depends on where the sensor is looking, one can determine a special shape of one of the surfaces that dramatically reduces the wavefront error over the entire FOR. This is often necessary, because such sensors are typically able to be manipulated and can therefore be adjusted to view through any region of the optical device 500. Referring back to FIG. 3, the change in a wavefront introduced by the mechanical deformation of the optical device 320 results from the lateral shift of the beam footprint from top to bottom of the optical device 320. In these scenarios, the surface shape encountered by the beam at the top of the optical device is slightly different from the surface shape it encounters at the bottom when the angle of incidence is non-zero, as shown in the left scenario 301 of FIG. 3. This is because the non-zero incidence angle causes significant lateral propagation as the beam 310 passes from the top to the bottom of the optical device 320—known as “beam shear,” in combination with the optical device 320 having deformation including a non-spherical component. Whenever a beam is sheared during propagation through a non-spherical portion of the optical device, as is the case with the left scenario 301 of FIG. 3, the wavefront change introduced at the top surface of the optical device is not being fully compensated by that introduced by the bottom surface, yielding a net wavefront error. Because the beam shear as well as the surface deformation seen by the beam is different for each point in the FOR, the wavefront error caused by the deformation is different for each such point. The classical approach clearly cannot work in this case, because full correction of one point in the FOR means that the error at other points will be exacerbated.

However, as illustrated in FIG. 5, the beam footprint shifts across the entire optical device 500 as the FOR is scanned from a beam footprint 510 at one angle of incidence through differing angles of incidence (AOI). A corrective surface profile can be defined in such a way that correction over the beam footprint at one point in the FOR does not preclude reducing WFE at other points in the FOR. Rather, the corrective surface profile provides correction at all points in the FOR. For example, the beam footprint at a large AOI (e.g., beam footprint 530) can be separate from the beam footprint at some lesser AOI (e.g., beam footprints 510, 520) Such beam footprints can overlap in part, or not overlap at all. A single surface can be defined that simultaneously reduces WFE for each beam footprint 510, 520, 530, and which is congruent (mathematically continuous) over the region of overlap, such as overlap region 515. This defined surface can be found using classical optimization techniques, such as damped least-squares optimization for reduction of a merit function. In accordance with the invention, this can be accomplished by using a large collection of FOR points, evenly distributed over the optical device, in the optimization process. The resulting surface will reduce WFE over much of the FOR. In accordance with this aspect of the invention, the step of defining a surface contour can be carried out using optimization routines for a plurality of points in the field of regard (FOR). In accordance with this aspect, a computer-based optical design program can be used, such as Zemax® by Zemax Development Corporation, CodeV® by Optical Research Associates or OSLO® by Lambda Research Corporation.

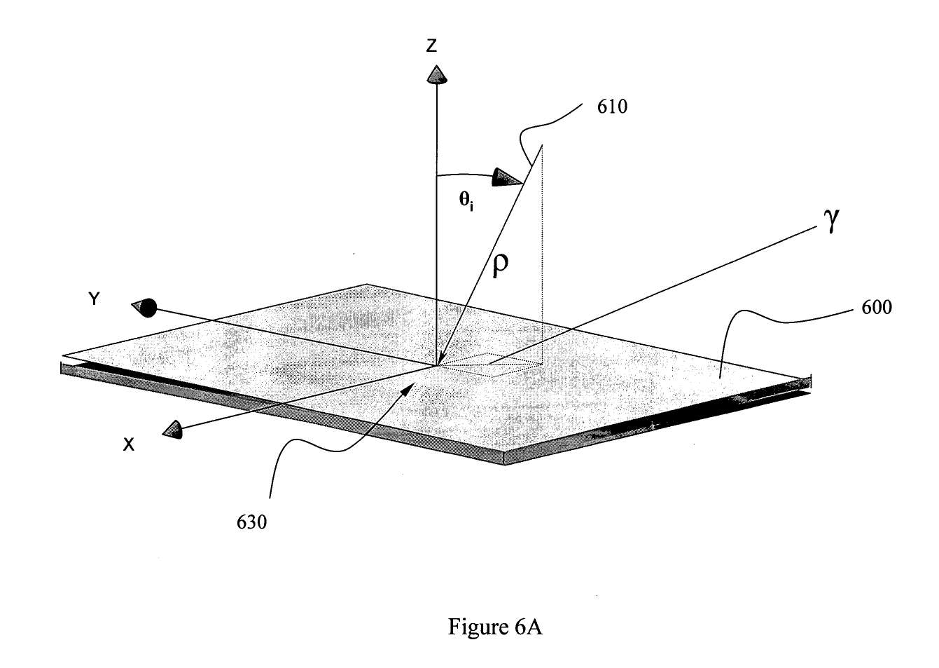

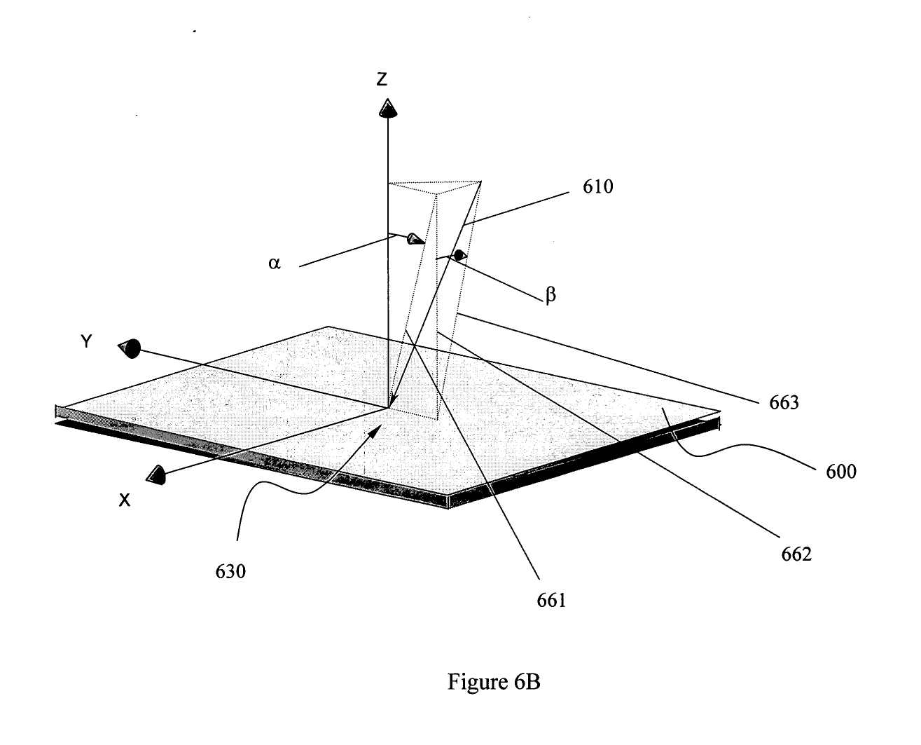

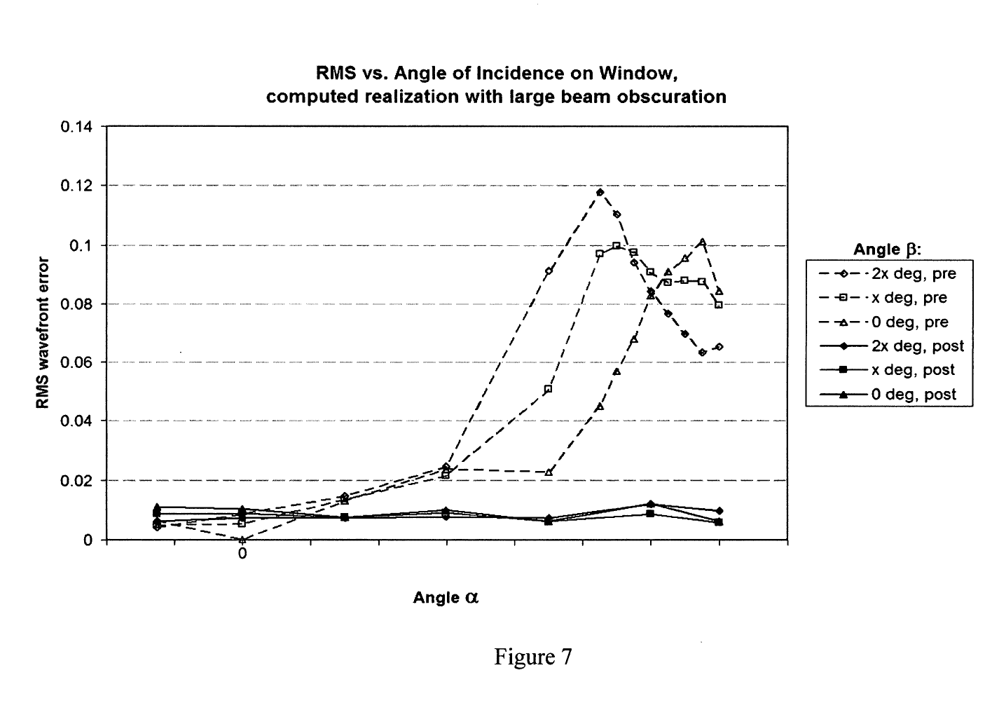

Examples, which are provided in FIGS. 6A, 6B and 7, illustrate that the WFE can be reduced by a factor of 5 or more at the worst points in the FOR, while not significantly negatively impacting WFE at points that are already acceptable. The result is an optical device that performs extremely well over the entire FOR that it services. FIG. 6A is a ray diagram for light incident upon an optical device 600 in accordance with the invention. A ray 610 from the incident beam arrives at the optical device 600 at an angle θ₁(theta) with respect to the Z-axis of a coordinate system 630, such that its projection onto the X-Y plane has finite components along both the X and Y axes; if the length of the ray is ρ (rho), and if the length of the ray projection onto the X-Y plane is γ, with an angle of incidence is θᵢ, then (gamma) γ=ρ·sine(θᵢ).

FIG. 6B is a further schematic diagram for light incident upon an optical device 600 in accordance with the invention. FIG. 6B shall aid understanding of FIG. 7. A projection of the original ray 610 can be projected onto the Y-Z plane, shown as 661. Here, the angle between this projection 661 and the Z axis is α (alpha). This angle will be referred to in FIG. 7. A projection of the ray 661 can further be projected onto the X-Z plane, which is shown as 662. We can also project the ray 661 itself onto the X-Z plane, which is shown in FIG. 6B as 663. The angle between these two projections (662, 663) is defined herein as β (beta). Thus, is possible to define the angle of incidence θᵢ (FIG. 6A) in terms of α and β. FIG. 7 uses these angle definitions.

FIG. 7 is a plot of RMS (root mean square) wavefront error with respect to angle α, as defined in FIG. 6B. Six data series are provided, three of which plot incident light for varying angle α, with three different fixed angles β (0, x, 2x ) before figuring with the method in accordance with the invention. The other three data series plot incident light for varying angle α with three different fixed angles β (0, x, 2x ) after figuring with the method in accordance with the invention. As can be seen, the wavefront error is dramatically reduced, particularly at large angles of incidence, when an optical device is treated in accordance with the invention.

An example process for arriving at corrective surface profile in accordance with the second aspect of the invention is as follows:
A. Model the deformations of upper and lower surfaces of optical device under mechanical load in Finite Element Analysis (FEA) software such as Nastran®. Quantify (and output) the surface deformations at a large number of points across each surface.
B. If necessary, convert the deformation information into a form compatible with the desired optical design and/or analysis software (e.g. Zemax®, CodeV®, OSLO®, or self-created code).
C. Model the transmitted wavefront error incurred by a number of beams of a given size as they propagate through the optical device at a selection of angles. Beam size and angles are typically chosen to correspond to the geometry of a sensor or other optical device which is looking through the optical device in question. The number of different beams (and hence footprints on the optical device) is chosen so that analysis is sufficiently representative of the full range of performance of the sensor, so that all beam footprints taken together will entirely cover the optical device (and most will overlap other footprints), but so that the calculations described in the following step are not unnecessarily encumbered by choosing an arbitrarily large number of angles/footprints. For example, it might make sense to choose angles varying in steps of 10°, but the change in wavefront error in steps of 1° may not be not significant enough to warrant the additional computing time of using that many beams.
D. Perform an optimization calculation in order to yield the corrective surface. As used herein, the term “Optimization” refers to a class of iterative automatic computation designed to search for solutions to complicated numerical problems. It is typically based on damped least-squares optimization methods, but in accordance with the invention may alternatively use other suitable methods. A typical optimization is done as follows:
   a. Establish a “merit function” which computes and provides a single numerical figure of merit for any given realization of the optical device, by simultaneously evaluating the transmitted wavefront error for all beams chosen as described in the previous step, and combining these numerical results according to a prescribed algorithm. The merit function will typically be set up to assign equal mathematical weighting for all chosen beams, though, if desired, certain beams can be given more or less mathematical weighting in the function to force the subsequent optimization routines to try harder or less hard to better the wavefront for that given beam. The latter may be useful, for example, if certain angles of incidence experience particularly worse wavefront error than others given their large amount of shear, or if certain angles (e.g. normal incidence) require very little correction.
   b. Set the profile of the desired corrective surface of the optical device to be variable during the optimization. More specifically, a polynomial form is chosen (e.g. a Zernike polynomial), and the coefficients describing the shape of this polynomial are all individually allowed to vary during optimization to arrive at the desired surface contour.
   C. Commence running the optimizing software. Each iteration in the calculation begins with the introduction of small random changes in the input parameters, followed by a recomputation of the merit function. The ‘direction’ in parameter space is noted by the software at each iteration, so that an improvement in the merit function is associated with the direction of changes made in that iteration. In this way, the defined merit function is strategically minimized as the variables are altered (i.e. the corrective surface contour is changed). Once the best optimization is reached, the merit function will have been minimized for all chosen beams. If said beams are chosen in sufficient increments, as discussed above, then the correction interpolated between said beams will be appropriate for those interpolated beams, even though they were not necessarily used during optimization. This allows the subject process to function over the entire FOR, and not just for a plurality of regions, even only using a finite plurality of regions to perform the optimization. Furthermore, the variables, as changed during the optimization process, will now describe a polynomial contour which defines the desired corrective surface shape.

It should be noted that while it is generally more efficient and therefore practical to use commercially available software packages as described above, use of such products should not be considered inherent to the invention. One could numerically compute the deformation of the window, numerically compute the wavefront error incurred (via “by-hand” ray tracing), and likewise write one's own optimization routine in a mathematical software package to accomplish the tasks described above.

Moreover, an example process which can be employed for the above-described first embodiment of the present invention, described in connection with FIG. 4, is much simpler that the immediately foregoing process. The first two steps above are the same. However, no transmitted wavefront or ray-trace calculations are necessary, and therefore, no optical design and/or analysis software is necessary. Once the surface deformations of the optical device under load are known, one merely fits a virtual spherical surface (that is, a conceptual target at this point in the process, not a real surface) to the deformed surface, and then finds the difference between this sphere and the deformed surface. This difference constitutes the glass to be removed, as by polishing. The fitting process involves choosing the radius of curvature (ROC) of the sphere, and its location relative to the deformed surface, such that the volume between them (amount of glass to be removed) is minimized. For the concave of the two surfaces (under load) of the optical device in question, the parameters of the fitting sphere are chosen so that the sphere touches at the center and at the edges of the deformed surface. (This is essentially a hand calculation.) In such a case, the glass to be removed is zero at the exact center of the surface and at its edge, and finite everywhere else.

For the other side of the optical device (which is convex under load), the same spherical parameters are used for the fitting sphere. To perform the fit, the sphere is merely located relative to the surface, until the volume of glass to remove is minimized. The sphere will also ‘touch’ the surface in this case, but not at center and edge. It will touch at almost exactly the same points as those on the opposite surface where the glass to be removed is maximum. In this case, the center and edges exhibit the greatest difference between the initial surface and the fitting sphere, and therefore will receive the maximum polishing. Note that the profiles of the glass to be removed from the two surfaces are complimentary, and in fact if one of them is flipped, they can be nested together. That is, if expressed as a thickness magnitude, the sum of the two profiles results yields a constant.

The term “spherical” in the context here means that any profile of the surface of an optical device in accordance with the invention is a segment of a circle. It is not necessary that all profiles of the fitting surface have the same ROC, as long as any and all profiles of the surface are segments of circles. Naturally, however, the same fitting surface must also be used for both sides of the optical device. Specifically, the ROC of the “sphere” that is fit across the long dimension of a rectangular window under load will be greater than the ROC across the short dimension. This kind of surface shape is often referred to as ‘cylinder’, because if a sphere having a ROC equal to either the longest or shortest ROC of the surface is fit to that surface, the difference between them will look like a segment of a cylinder.

The methods and systems of the present invention, as described above and shown in the drawings, provide for optical devices with superior properties including reduced wavefront error over narrow or wide fields of regard. It will be apparent to those skilled in the art that various modifications and variations can be made in the device and method of the present invention without departing from the spirit or scope of the invention. Thus, it is intended that the present invention include modifications and variations that are within the scope of the appended claims and their equivalents.

What is claimed is:

1. A method of correction of load-induced optical distortion in an optical device, the method comprising:
a) subjecting an optical device having a first morphology to a predetermined loading condition;
b) determining a deformation to a second morphology of the optical device under said predetermined loading condition; and
c) removing material from at least one surface of said optical device to compensate for said deformation.

2. The method of claim 1, wherein material is removed from two surfaces to compensate for said deformation to yield an optical device having a substantially spherical morphology when subject to said loading condition.

3. The method of claim 2, wherein at least one surface of said optical device, when the optical device exhibits said first morphology, has a radius of curvature of between about 1000 cm and infinity

4. The method of claim 1, wherein material is removed from one surface of the optical device to optically compensate for said deformation by forming a surface adapted and configured to substantially reduce wavefront error due to said deformation across a field of regard.

5. The method of claim 1, wherein following said step of removing material from said optical device, said optical device exhibits a third morphology when not subject to said predetermined loading condition, which third morphology is the inverse of said second morphology.

6. The method of claim 1, wherein the first morphology of said optical device is substantially planar.

7. The method of claim 1, wherein the second morphology of said optical device is substantially planar.

8. The method of claim 1, wherein the second morphology is determined using computerized modeling means.

9. The method of claim 1, wherein said step of removing material includes polishing the surface of the optical device in selected areas.

10. The method of claim 1, wherein the step of polishing is effectuated by a computer-controlled polishing device.

11. The method of claim 1, wherein first and second surfaces of the optical device pane are polished to compensate for deformation.

12. The method of claim 1, wherein between about 0.0005 inch and 0.005 inch (0.00127 cm to 0.0127 cm) is removed by polishing a surface of the optical device.

13. A method of correction of load-induced optical distortion in an optical device, the method comprising:
a) subjecting the optical device to a predetermined loading condition;
b) determining a deformation of the optical device under a predetermined loading condition;
c) defining a surface contour across a surface of the optical device to substantially reduce wavefront error due to said deformation across a field of regard when the optical device is subject to said predetermined loading condition; and
d) removing material from a surface of said optical device to create the defined surface contour.

14. The method of claim 13, wherein a finite plurality of regions are selected and used to define said surface contour using optimization techniques which minimize a wavefront error merit function.

15. The method of claim 13, wherein material is removed from only one surface of the optical device.

16. The method of claim 13, wherein the step of determining a deformation of the optical device is carried out on a computer adapted and configured to determine the deformation.

17. The method of claim 13, wherein the step of defining a surface contour of the optical device is carried out on a computer adapted and configured to define the contour.

18. An optical device for use under a predetermined loading condition, formed by the method of claim 13.
